(19) United States
(12) Patent Application Publication
(10) Pub. No.: US 2011/0215489 A1
(43) Pub. Date: Sep. 8, 2011

(54) LENS FORMING METAL MOLD, LENS FORMING METHOD, LENS, AND PICKUP DEVICE

(75) Inventors: Shungo HANASHIRO, Kanagawa (JP); Akihiro SUGIYAMA, Tochigi (JP); Hiroshi KANAZAWA, Saitama (JP)

(73) Assignee: HOYA CORPORATION, Tokyo (JP)

(21) Appl. No.: 13/039,601

(22) Filed: Mar. 3, 2011

(30) Foreign Application Priority Data
Mar. 5, 2010 (JP) 2010-049026

(51) Int. Cl. B29D 11/00; B29C 45/03; B29C 45/34

(52) U.S. Cl. 264/1.1; 425/470

(57) ABSTRACT

A lens forming metal mold comprising: a first metal mold portion that forms a first lens surface of a lens; and a second metal mold portion that forms a second lens surface of the lens. An air vent groove is formed on at least one contacting surface of a contacting surface of the first metal mold portion contacting with the second metal mold portion and a contacting surface of the second metal mold portion contacting with the first metal mold portion. A convex surface serving to form a concaved portion on the lens for accommodating a burr caused by the air vent groove is formed at least around the air vent groove on an outer circumference forming surface of the at least one contacting surface on which the air vent groove is formed, the outer circumference forming surface serving to from a tubular surface of the lens.

### TECHNICAL FIELD

The present invention relates to a lens forming metal mold, a lens forming method, a lens, and a pickup device.

### BACKGROUND

An optical disc drive for reading information from an optical disk, such as CD or DVD, has a pickup device. The pickup device includes at least one laser light source and a lens for focusing a laser light beam emitted from the laser light source on an optical disk.

In general, the lens is a resin molded product formed by mold injection. One example of metal molds for forming a lens is shown in Japanese Patent Provisional Publication No. 2008-126611A (hereafter, referred to as Patent Document 1).

As shown in the patent document 1, when a lens is formed through mold injection, it is necessary to form an air vent groove on the metal mold for pushing out an air inside of the metal mold. And, a burr is formed on the lens by the resin injected into the metal mold and reaching to the air vent groove.

Such a burr of the lens can interfere with a lens holder of the pickup device, and can be an obstacle for positioning the lens. Therefore, conventionally, a cutting process for removing the burr was performed after forming the lens.

### SUMMARY

The present invention is achieved to solve the above described problem. The present invention is advantageous in that it provides a lens forming metal mold and a lens forming method for forming a lens which can be attached to the lens holder without performing a burr removing process after forming, and the lens formed by such a method and a pickup device on which the lens is mounted.

According to an aspect of the invention, there is provided a lens forming metal mold comprising: a first metal mold portion that forms a first lens surface of a lens; and a second metal mold portion that forms a second lens surface of the lens. An air vent groove is formed on at least one contacting surface of a contacting surface of the first metal mold portion contacting with the second metal mold portion and a contacting surface of the second metal mold portion contacting with the first metal mold portion. A convex surface serving to form a concaved portion on the lens for accommodating a burr caused by the air vent groove is formed at least around the air vent groove on an outer circumference forming surface of the at least one contacting surface on which the air vent groove is formed, the outer circumference forming surface serving to from a tubular surface of the lens.

With this configuration, the burr extends from the concaved portion of the tubular surface of the lens. Thus, a tip of the burr does not protrude greatly outward, and the burr does not interfere with the lens holder of the pickup device, even if the burr is not removed. Therefore, the lens formed with the metal mold of the present invention can be attached to the lens holder without removing the burr.

In at least one aspect, the convex surface may be formed in a shape which is along the tubular surface of the lens.

In at least one aspect, that the tubular surface of the lens may be a cylindrical surface.

In at least one aspect, a height of the convex surface of the outer circumference forming surface may be greater than or equal to 1.5 times of a thickness of the air vent groove.

In at least one aspect, the air vent groove may be formed on both of the first metal mold portion and the second metal mold portion.

According to another aspect of the invention, there is provided a lens forming method, comprising: forming a lens by injecting a molten resin material into one of the above described lens forming metal molds.

According to another aspect of the invention, there is provided a lens produced by the above described lens forming method.

According to another aspect of the invention, there is provided a pickup device including one of above described lenses and a holder for holding the lens.

As described above, according to the present invention, the lens forming mold and lens forming method for forming a lens which can be attached to the lens holder without performing a burr removing process after forming are realized, and the lens and the pickup device are realized.

### BRIEF DESCRIPTION OF THE DRAWINGS

FIG. 1 is a sectional view of a lens and a metal mold for forming a lens, according to an embodiment of the present invention.

FIG. 2 shows a lens which has been formed and placed below an upper metal mold portion and a concaved portion of the upper metal mold portion.

FIG. 3 is an explanatory illustration for explaining a situation where the lens is mounted on a lens holder.

### DETAILED DESCRIPTION OF EMBODIMENTS

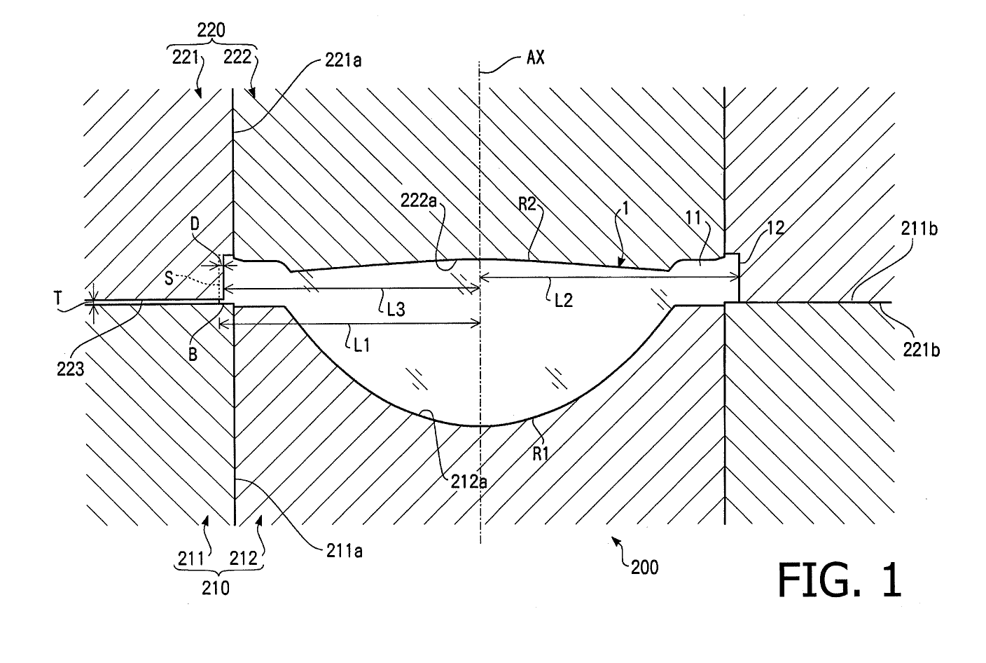

Hereinafter, an embodiment of the present invention is explained with reference to the accompanying drawings. In the embodiment, a lens 1 is made of a plastic and manufactured through mold injection, in which a molten resin is injected into a metal mold 200. FIG. 1 shows a sectional view of the lens 1 and a metal mold for forming the lens 1.

The lens 1 is a lens such that a first lens surface R1 is formed on one of surfaces of the lens (downward in the figure) and a second lens surface R2 is formed on the other one of the surfaces of the lens (upward in the figure). Both of the first lens surface R1 and the second lens surface R2 are convex surfaces. The lens 1 functions as a convex lens.

The lens 1 is used for a pickup device for reading out information from an optical disk, or for recording information on an optical disk. The pickup device causes a laser beam from a laser light source to enter the lens 1, and irradiates the laser beam collected by the lens 1 on an optical disk. When data recorded on an optical disk is read out, the laser beam enters a photodetector of the pickup device through the lens 1, after reflecting on the optical disk. Namely, the laser beam reflected on the optical disk is eventually read by the photodetector. Here, the laser light source and the photodetector are placed on a side of the first lens surface R1. On the other hand, the optical disk is placed on a side of the second lens surface R2.

Next, a method of forming the lens 1 is explained. As shown in FIG. 1, the metal mold 200 for forming the lens 1 includes a lower metal mold portion 210 and an upper metal mold portion 220. The lower metal mold portion 210 includes an outer metal mold (down) 211 and an inner metal mold (down) 212. A hole 211a is formed in the outer metal mold (down) 211, and the inner metal mold (down) 212 is placed inside the hole 211a of the outer metal mold (down) 211. Further, the upper metal mold portion 220 includes an outer metal mold (up) 221 and an inner metal mold (up) 222. A hole 221a is formed in the outer metal mold (up) 221, and the inner metal mold (up) 222 is placed inside the hole 221a of the outer metal mold (up) 221. Both of an upper surface 211b of the outer metal mold (down) 211 and a lower surface 221b of the outer metal mold (up) 221 are surfaces perpendicular to an optical axis AX of the lens 1. The upper surface 211b of the outer metal mold (down) 211 and the lower surface 221b of the outer metal mold (up) 221 are in contact with each other. Therefore, the outer metal mold (up) 221 is supported on the outer metal mold (down) 211.

A concaved portion 212a for forming the first lens surface R1 of the lens 1 is formed on the inner metal mold (down) 212. Further, a concaved portion 222a for forming the second lens surface R2 of the lens 1 is formed on the inner metal mold (up) 222.

In the embodiment, the inner metal mold (down) 212 is movable with respect to the outer metal mold (down) 211 in the direction along the optical axis AX of the lens 1. Similarly, the inner metal mold (up) 222 is movable with respect to the outer metal mold (up) 221 in the direction along the optical axis AX of the lens 1. The lenses 1 with various thicknesses can be formed by moving the inner metal mold (down) 212 and the inner metal mold (up) 222 along the optical axis AX.

Further, both of an inner circumferential surface of the hole 221a of the outer metal mold (up) 221 and an inner circumferential surface of the hole 211a of the outer metal mold (down) 211 are placed on a same cylindrical surface centered by the optical axis AX. With such a configuration, both of the holes 211a and 221a can be formed at once by overlapping the outer metal mold (up) 221 with the outer metal mold (down) 211 and drilling them with a drill. The inner surfaces of the holes 211a and 221a can be concentric cylindrical surfaces with extremely high precision by lap finishing the holes 211a and 221a while overlapping the outer metal mold (up) 221 with the outer metal mold (down) 211. In this manner, since the holes 211a and 221a are concentrically formed with extremely high precision, the inner metal mold (up) 222 and the inner metal mold (down) 212 are positioned with extremely high precision in a state in which the inner metal mold (up) 222 is attached to the hole 221a and the inner metal mold (down) 212 is attached to the hole 211a. Therefore, the concaved portion 222a of the inner metal mold (up) 222 and the concaved portion 212a of the inner metal mold (down) 212 are assembled to the outer metal mold (up) 221 and the outer metal mold (down) 211, respectively, without eccentricity. Consequently, the formed lens 1 is a lens such that an optical axis of the first lens surface R1 coincides with an optical axis of the second lens surface R2 with extremely high precision.

As described above, the lens 1 of the embodiment is formed through mold injection. Therefore, an air vent groove 223 for communicating an inner portion of the metal mold 200 with an outer portion of the metal mold 200 is formed on the bottom surface of the outer metal mold (up) 221 so as to discharge an air inside of the metal mold 200 during formation. When the molten resin is injected inside of the metal mold 200 during mold injection, the air inside of the metal mold 200 is pushed out to the outside of the metal mold through the air vent groove 223 by the injected resin. Here, a thickness T (vertical dimension in FIG. 1) of the air vent groove 223 is about 0.01 to 0.02 mm.

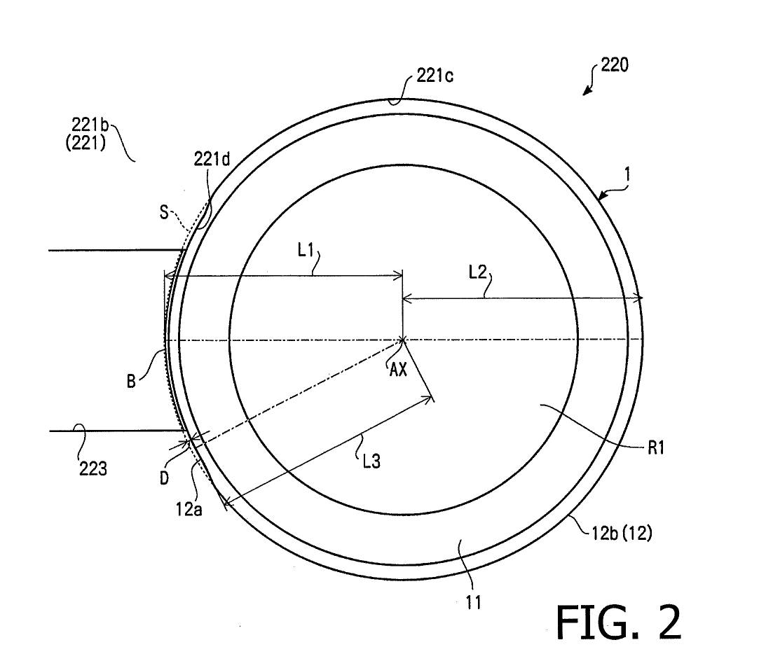

Burrs formed on the lens 1 are explained below. FIG. 2 shows lens 1 placed below the upper metal mold portion 220 and the concaved portion 222a (FIG. 1) of the upper metal mold portion 220, after formation, in the embodiment. As described above, since the air vent groove 223 is formed on the metal mold 200, a burr B is formed on the lens 1 when the resin reaches to the air vent groove 223 during formation.

As shown in FIGS. 1 and 2, the lens 1 of the embodiment has a shape such that a ring-shaped flange portion 11 is formed outside the first lens surface R1 and the second lens surface R2 in a radial direction. The lens 1 is configured to be held by a lens holder provided in the pickup device at the flange portion 11. The lens holder has a cylindrical surface having substantially the same diameter as a diameter of an outer circumferential surface 12 of the flange portion 11 of the lens 1, and positioning of the lens 1 in the radial direction is performed by contacting the cylindrical surface of the lens holder with the outer circumferential surface 12 of the flange portion 11 of the lens 1.

As shown in FIG. 2, in the embodiment, a convex surface 221d protruding toward inside of the lens 1 in the radial direction is formed at a portion around the air vent groove 223 of an outer circumference forming surface 221c for forming the outer circumferential surface 12 of the lens 1, on the outer metal mold (up) 221. Namely, on the outer circumferential surface 12 of the lens 1, a portion 12a closer to the burr B is a concaved portion having a smaller diameter than a diameter of a principal portion 12b of the outer circumferential surface 12. Therefore, the burr B extends along the air vent groove 223 from the concaved portion 12a which is placed at an inner side in the radial direction than the principal portion 12b of the outer circumferential surface 12. Consequently, a length L1 which is a length from the optical axis AX of the lens 1 to a tip of the burr B becomes shorter than a length L2 which is a length from the optical axis AX to the principal portion 12b of the outer circumferential surface 12 (namely, a virtual cylindrical surface S (a dashed line portion in the figure) which is formed if the principal portion 12b of the outer circumferential surface 12 is extended does not cross with the burr B). When the lens 1 is attached to the lens holder of the pickup device, the burr does not interfere with the cylindrical surface of the lens holder. Thus the lens 1 can be accurately positioned to the lens holder.

Here, it is preferable that a size of the convex surface 221d of the metal mold 200 is as small as possible. Therefore, the convex surface 221d is formed in a neighborhood of the air vent groove 223, and has an arc like shape along the outer circumference forming surface 221c which is a cylindrical surface.

Further, in the embodiment, a height D of the convex surface 221d is set to greater than or equal to 1.5 times of the thickness T (see FIG. 1) of the air vent groove 223 (for example, D=0.03 mm) With this configuration, a depth of the concaved portion of the lens 1, namely, a distance between the virtual cylindrical surface S and the concaved portion 12a (a difference between a radius L2 at the principal portion 12b of the outer circumferential surface of the lens 1 and a radius L3 at the concaved portion 12a of the lens 1) is substantially equal to the height D of the convex surface 221d so that it is ensured that the burr B is not crossed with the virtual cylindrical surface S (the dashed line portion in the figure).

Further, in the embodiment, the air vent groove is formed only on the outer metal mold (up) 221. However, the air vent groove can be formed only on the outer metal mold (down) 211, or the air vent groove can be formed on both of the outer metal mold (up) 221 and the outer metal mold (down) 211.

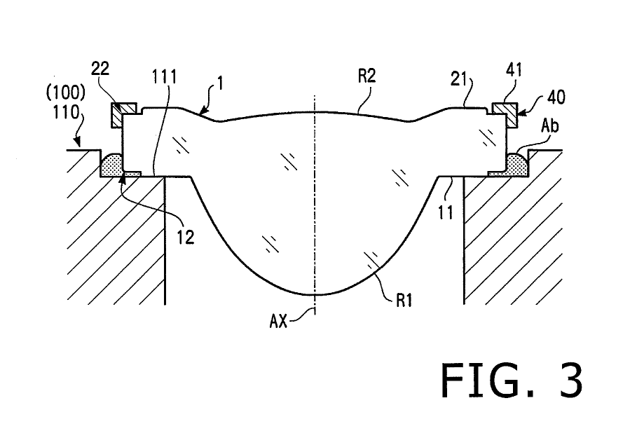

FIG. 3 illustrates a situation where the lens 1 is mounted on a lens holder 110 provided in a pickup device 100. The pickup device 100 is configured to cause the laser beam to be incident on the lens 1 so that the laser beam converged by the lens 1 is incident on the optical disc. As shown in FIG. 3, the lens holder 110 has a holding surface 111 on which the lens 1 is placed. The lens 1 is fixed on the lens holder 110 by placing the flange portion (mounting surface) 11 of the lens 1 on the holding surface 111 of the lens holder 110 and, subsequently, injecting an adhesive Ab into a corner 12′ of the mounting surface of the lens 1. As described, the optical disk is in close proximity to the second lens surface R2 of the lens 1. Further, a cap 40 made with soft resin is attached at a corner 22 of the lens 1 so as not to damage the optical disk by contacting the optical disk rotating at a high speed with the corner 22 at the side of the second lens surface R2 of the lens 1. When a cap 40 is attached to the lens 1, an upper surface 41 of the cap 40 is placed at a higher position than the position of the surface of the second lens surface R2 of the lens 1 (namely, closer to the optical disk). Therefore, even if the optical disk is inclined to the second lens surface R2 of the lens 1, the optical disk does not contact with the lens 1. Further, a surface for detecting inclination 21 (a third surface portion) which is a ring-shaped surface perpendicular to the optical axis AX of the lens 1 is formed around a periphery of the second lens surface R2. During attachment of the lens 1 to the lens holder 110, it can be detected whether the lens 1 is inclined with respect to the lens holder 110 based on an angle of reflected light by irradiating a laser beam to the surface for detecting inclination 21. An inclination of the lens 1 is adjusted based on a result of the above detection.

This application claims priority of Japanese Patent Application No. P2010-049026, filed on Mar. 5, 2010. The entire subject matter of the applications is incorporated herein by reference.

What is claimed is:

1. A lens forming metal mold comprising:
a first metal mold portion that forms a first lens surface of a lens; and
a second metal mold portion that forms a second lens surface of the lens,
wherein:
an air vent groove is formed on at least one contacting surface of a contacting surface of the first metal mold portion contacting with the second metal mold portion and a contacting surface of the second metal mold portion contacting with the first metal mold portion; and
a convex surface serving to form a concaved portion on the lens for accommodating a burr caused by the air vent groove is formed at least around the air vent groove on an outer circumference forming surface of the at least one contacting surface on which the air vent groove is formed, the outer circumference forming surface serving to from a tubular surface of the lens.

2. The lens forming metal mold according to claim 1, wherein the convex surface is formed in a shape along the tubular surface of the lens.

3. The lens forming metal mold according to claim 2, wherein the tubular surface of the lens is a cylindrical surface.

4. The lens forming metal mold according to claim 3, wherein a height of the outer circumference forming surface is greater than or equal to 1.5 times of a thickness of the air vent groove.

5. The lens forming metal mold according to claim 4, wherein the air vent groove is formed on both of the first metal mold portion and the second metal mold portion.

6. A lens forming method, comprising:
forming a lens by injecting a molten resin material into the lens forming metal mold according to claim 1.

7. A lens produced by the lens forming method according to claim 6.

8. A pickup device for an optical disk, comprising:
the lens according to claim 7; and
a holder for holding the lens.
